(19) United States
(12) Patent Application Publication
(10) Pub. No.: US 2010/0270347 A1
(43) Pub. Date: Oct. 28, 2010

(54) SYSTEMS FOR DETECTING OBJECTS IN THE GROUND

(75) Inventors: Robert A. Kinzle, Polson, MT (US); David W. Simmons, Middleton, ID (US); Layne E. Simmons, Middleton, ID (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: WILLOWVIEW CONSULTING, LLC, Middleton, ID (US)

(21) Appl. No.: 12/428,356

(22) Filed: Apr. 22, 2009

(51) Int. Cl. B60R 11/00

(52) U.S. Cl. 224/488

(57) ABSTRACT

Disclosed herein are embodiments of a detection system having the ability to avoid damage when coming into contact with a fixed object. The system includes a head containing a sensor for detecting an object of interest in the ground. The sensor head is disposed at the distal end of a boom. The boom is connected to a vehicle. The sensor head precedes the vehicle, and detects an object of interest before the vehicle passes over the object. The sensor head may pivot with respect to the boom, and the height of the sensor head from the ground may be adjusted. A tensioning device may be employed to maintain the sensor head in a first orientation. The tensioning device may exert a restoring force when the sensor head is not in the first orientation to cause the sensor head to return to the first orientation.

### TECHNICAL FIELD

The present disclosure relates generally to systems for detecting objects in the ground.

### BRIEF DESCRIPTION OF THE DRAWINGS

FIG. 1 is a perspective view illustrating a detection system in an extended position, according to one embodiment.

FIG. 2 is a perspective view illustrating the detection system of FIG. 1 in a stowed position, according to one embodiment.

FIG. 3 is a top view of a sensor head and a boom in a first orientation, according to one embodiment.

FIG. 4 is a perspective view of a sensor head and a boom in a second orientation, according to one embodiment.

FIG. 5 is a side view of a sensor head, according to one embodiment.

FIG. 6 is a cross-sectional view taken along line 6-6 in FIG. 3, according to one embodiment.

### DETAILED DESCRIPTION OF PREFERRED EMBODIMENTS

Disclosed herein are systems that relate generally to detecting objects in the ground. Mobile and lightweight detection systems may be used for a variety of purposes, including but not limited to the detection of land mines, improvised explosive devices (IEDs), unexploded ordinance, weapons caches, or any other objects of interest. In combat situations, a mobile and lightweight detection system may allow for the safe passage of troops and other personnel through potentially mined areas without significantly increasing the amount of equipment a unit carries. Special operations forces, in particular, may benefit from a mobile and light weight detection system because special operations forces often operate in areas not normally associated with conventional ordinance clearance sweeps. In peacetime, humanitarian organizations may utilize a detection system to search sites where conflict occurred, in order to safely remove any threat posed by remaining ordinance. Law enforcement may also utilize detection systems to search for explosive devices and other threats.

In operation a mobile detection system may come into contact with certain objects (e.g. rocks, vegetation, uneven terrain, and the like) that are fixed in place. If the system is rigid, and comes into contact with a fixed object, either the system or the fixed object gives way. In such a scenario, the system may suffer damage. A flexible system, on the other hand, may be better able to overcome such objects without damage to the system.

Disclosed herein are embodiments of a detection system having the ability to avoid damage when coming into contact with a fixed object. The system includes a sensor head containing a sensor for detecting an object of interest in the ground. Various types of sensors may be employed, including metal detectors, magnetometers, radar systems, ultrasound system, and the like. The sensor head is disposed at the distal end of a boom. The boom is connected to a vehicle. The sensor head precedes the vehicle, and detects the object in the ground before the vehicle passes over the object.

In one application, the systems disclosed herein are used to search for land mines and other weapons that are deployed in the ground. The term land mine, as used herein, refers to any form of explosive device that may be triggered by an operator or by the proximity of a vehicle or person. The term land mine is intended to encompass IEDs, pressure plate IED's (PPIEDs), anti-tank mines, anti-personnel mines, explosive devices specifically manufactured to be placed on or in the ground, or other forms of unexploded ordinance. Of course, the systems disclosed herein may also be utilized in other applications involving locating an object in the ground.

The sensor head may pivot with respect to the boom. In certain embodiments, a lock mechanism may be configured to lock the sensor head in a first orientation with respect to the boom, and to release the sensor head from the first orientation upon the application of a threshold force to the sensor head. When the lock mechanism releases, the sensor head may then rotate to a second orientation with respect to the boom in response to the application of the threshold force. In some embodiments, the lock mechanism includes a ball detent.

A tensioning device may be employed to maintain the sensor head in a first orientation. The tensioning device exerts a restoring force when the sensor head is not in the first orientation, to cause the sensor head to return to the first orientation. In one embodiment, the tensioning device includes two elastic cables attached to the sensor head and the boom. When the sensor head rotates, one of the cables is stretched. When the force that caused the rotation is removed, the stretched cable contracts, and causes the sensor head to rotate back to the first orientation.

The height of the sensor head above the ground may be adjusted. In one embodiment, the boom is connected to a vehicle using a hinge joint. The hinge joint allows the boom and the sensor head to be raised and lowered. A winch may be used to raise and lower the boom and the sensor head. In certain embodiments, the system may automatically adjust the height of the sensor head with respect to the ground. In other embodiments, a leading edge protector may be disposed on the sensor head, and may be configured to push the sensor head up and over fixed objects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer readable storage medium), a method, and a product of a process.

The phrases “coupled to,” “connected to,” and “in communication with” refer to any form of interaction between two or more entities, including mechanical, electrical, magnetic, and electromagnetic interaction. Two components may be connected to each other even though they are not in direct contact with each other and even though there may be intermediary devices between the two components.

Furthermore, the described features, structures, or characteristics may be combined in any suitable manner in one or more embodiments. Those skilled in the art will recognize that the teachings of the present disclosure can be practiced without one or more of the specific details, or with other methods, components, materials, etc. In other instances, well-known structures, materials, or operations are not shown or are not described in detail to avoid obscuring aspects of the present disclosure.

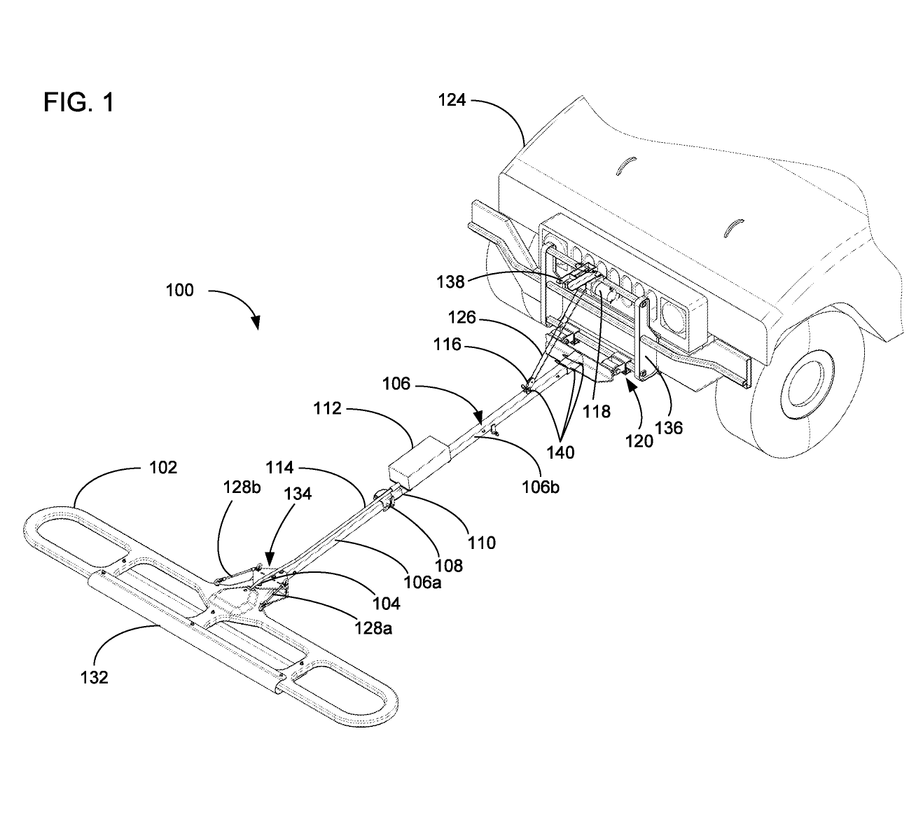

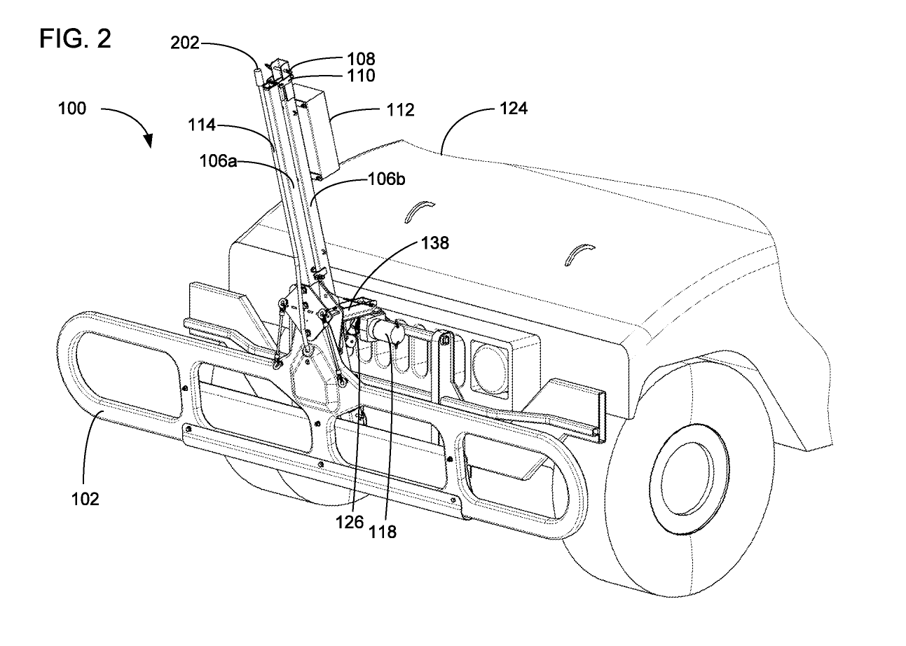

With reference to the accompanying drawings, FIG. 1 illustrates a detection system 100 configured for detecting an object in the ground. Detection system 100 includes a sensor head 102 mounted to a boom 106. Boom 106 includes two sections, a distal boom section 106a and a proximal boom section 106b. A boom joint 110 is disposed between distal boom section 106a and proximal boom section 106b. Boom joint 110 may be embodied as a hinge. As illustrated in FIG. 2, boom joint 110 may bend, allowing distal boom section 106a and proximal boom section 106b to be held in a plane that is approximately perpendicular to the ground. As illustrated in comparing FIG. 1 and FIG. 2, the distance between sensor head 102 and a vehicle 124 in the extended position is greater than the distance between sensor head 102 and vehicle 124 in the stowed position. A boom pin 108 may be used to secure distal boom section 106a and proximal boom section 106b in the extended position illustrated in FIG. 1. In some embodiments, a remotely activated pin may be used so that boom 106 may be moved between the extended position (shown in FIG. 1) and the stowed configuration (shown in FIG. 2) without manual assembly by an operator of detection system 100. In other embodiments, the boom may have multiple pin positions, allowing the boom to be made shorter or longer, as desired.

Boom 106 is attached to vehicle 124 using a vehicle mount 136. Boom 106 is connected to vehicle mount 136 at a hinge joint 120. Hinge joint 120 includes two receiver hitches with two pin connectors. The two receiver hitches may help to stabilize the boom and prevent sway and bounce of boom 106 and sensor head 102. A winch 118 is also connected to vehicle mount 136. In certain embodiments, vehicle mount 136 is customized to a particular vehicle, while boom 106 is generic and is able to be mounted to a plurality of different types of vehicle mounts. Winch 118 is connected to a cable 126 running through a pulley 116, which is connected to proximal boom section 106b. Winch 118 may be embodied as a commercially available 2,000 pound winch, and may receive power from vehicle 124. Additional pulleys may be used in alternative embodiments to achieve greater mechanical advantage, to allow greater accuracy in adjusting the height of sensor head 102, or to control transient motion (e.g. bending or vibration of boom 106).

As cable 126 is drawn in by winch 118, the height of sensor head 102 from the ground increases. Similarly, as cable 126 is let out by winch 118, the height of sensor head 102 decreases. Increasing the height of sensor 102 with respect to the ground may increase the ability to navigate rough terrain, while positioning sensor head 102 near the ground may increase the sensitivity of the sensor to an object in the ground by decreasing the distance between the sensor and the object. The optimal height of sensor head 102 above the ground is influenced by a number of factors, including the type of sensor, soil conditions, terrain, and the like. These considerations may be balanced by raising or lowering sensor head 102 while detection system 100 is in operation.

A plurality of pins 140 may be used to connect boom 106 to hinge joint 120, and to connect pulley 116 to proximal boom section 106b. The plurality of pins 140 may be removed in order to quickly detach boom 106 from vehicle 124. In certain embodiments, a safety strap (not shown) may be included to maintain boom 106 in an elevated position in case winch 118 fails and spools out cable 126. Winch 118 may be used to move proximal boom section 106b into the stowed configuration (shown in FIG. 2) by drawing in cable 126.

In certain embodiments, a distance sensor (not shown) and control system (not shown) may be utilized to automatically adjust the height of sensor head 102 above the ground. The distance sensor may determine the distance between sensor head 102 and the ground and provide the distance to the control system. The control system may control winch 118 and may raise or lower sensor head 102 as appropriate, in order to maintain a desired distance between sensor head 102 and the ground. In other embodiments, a user may raise and lower boom 106 from the cab of vehicle 124. In still other embodiments, a motor may be located proximate to hinge point 110 in place of winch 118 and cable 126.

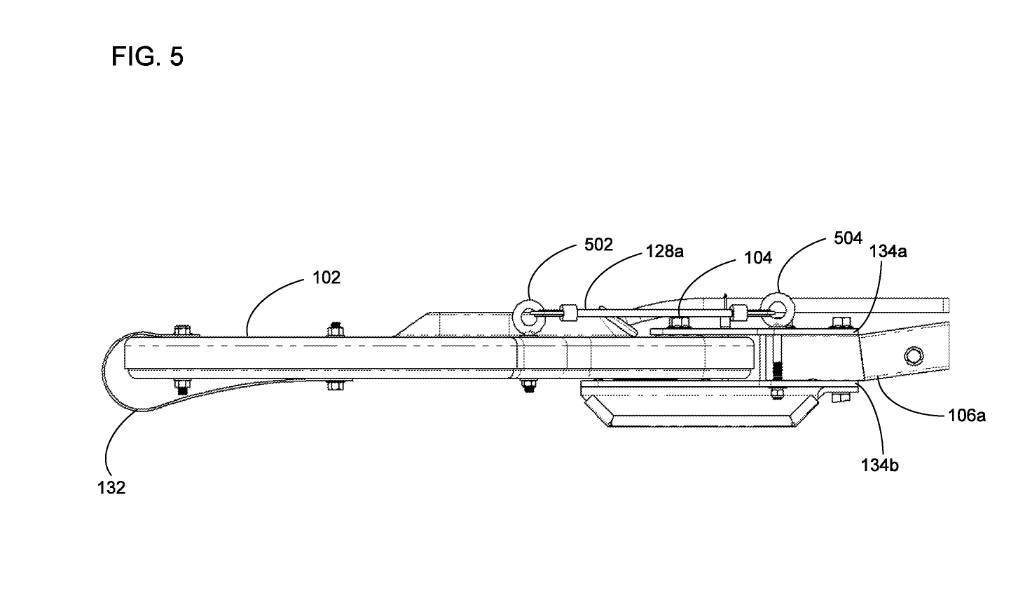

Sensor head 102 is pivotally connected to the distal end of distal boom section 106a. A head attachment assembly 134 is disposed at the distal end of distal boom section 106a. As better shown in FIG. 5, head attachment assembly 134 includes an upper head attachment assembly 134a and a lower head attachment assembly 134b. Sensor head 102 is received between upper head attachment assembly 134a and lower head attachment assembly 134b.

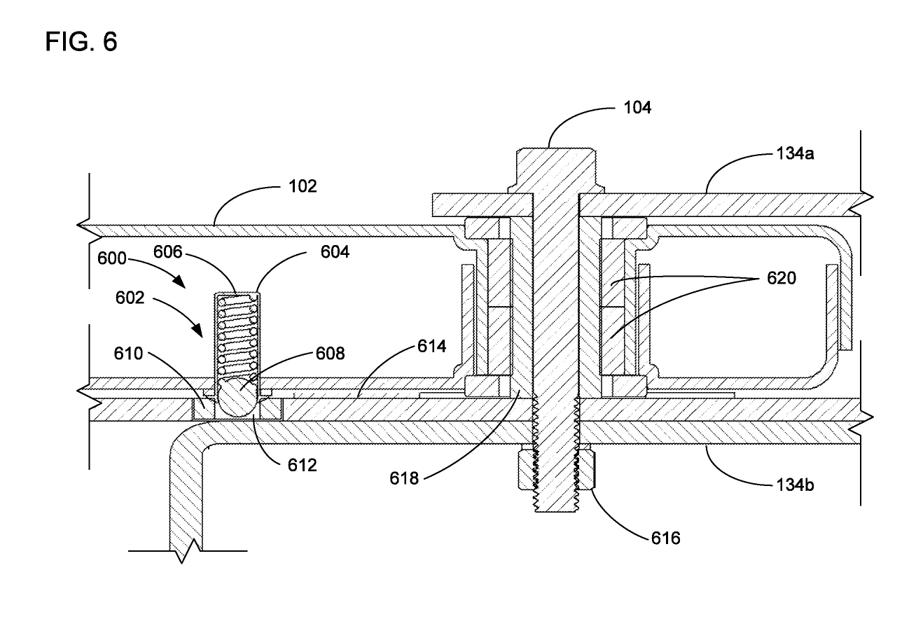

Sensor head 102 pivots about pivot bolt 104 in a plane that is substantially parallel to the plane of boom 106. A lock mechanism (shown in one embodiment as ref. no. 600 in FIG. 6) may be configured to lock sensor head 102 in the orientation shown in FIG. 1. The lock mechanism may further be configured to release sensor head 102 from the orientation shown in FIG. 1 upon the application of a threshold force to sensor head 102. A threshold force may be applied, for example, when sensor head 102 comes into contact with a fixed object (i.e. a rock or other protrusion from the ground) while detection system 100 is in operation.

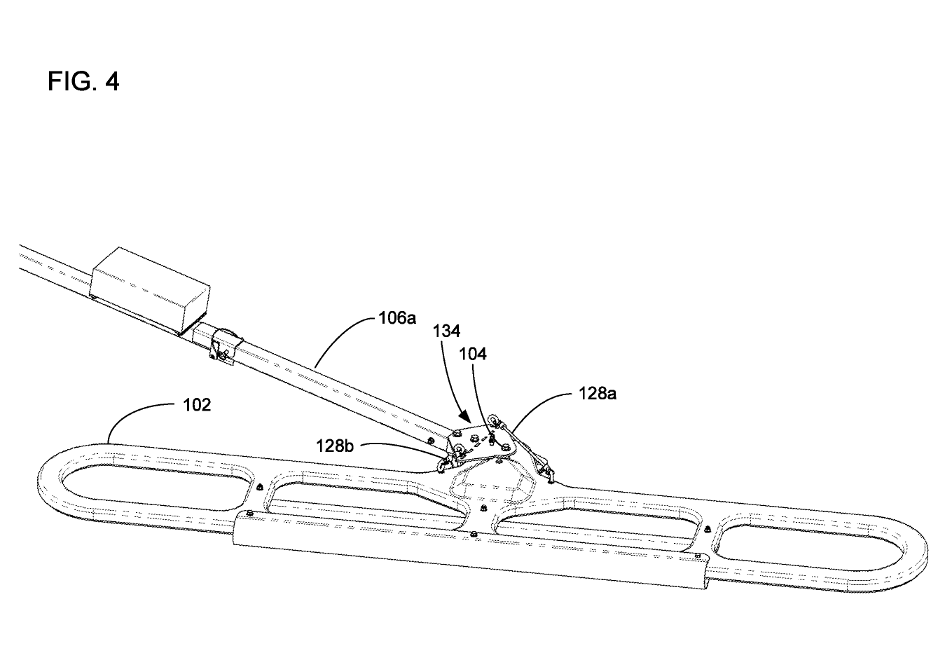

When sensor head 102 contacts a fixed object, and sufficient force is exerted, sensor head 102 may pivot into an orientation as illustrated in FIG. 4. By pivoting, sensor head 102 may avoid damage that may otherwise be caused by the impact of sensor head 102 against a fixed object. Pivoting allows sensor head 102 to avoid fixed objects that contact sensor head 102 near its outer edges.

Returning to a discussion of FIG. 1, in one embodiment sensor head 102 contains a metal sensor for detecting metal objects. The metal sensor may comprise the EM61 Flex System, available from Geonics Limited, Mississauga, Ontario, Canada (the “The EM61 Flex System”). The EM61 Flex System uses two coil pulse induction to detect ferrous and non-ferrous metal objects. In other embodiments, sensor head 102 may contain a magnetometer, a radar system, an ultrasound system, or other type of system for detecting an object in the ground.

In order to avoid interference with a metal sensor, in embodiments comprising a metal sensor, components of detection system 100 located near the metal sensor may be made of non-metallic materials. Distal boom section 106a, head 102, and head attachment assembly 134 may be made of fiber reinforced plastic or glass reinforced plastic, in order to minimize interference with the metal sensor. Other components, such as pivot bolt 104, may be fabricated using fiberglass. Components of detection system 100 that are separated from the metal sensor by a sufficient distance may be made of metal. In one embodiment, proximal boom section 106b is made of stainless steel to increase rigidity and minimize movement (e.g. sway and bounce). The recommended separation from metal components varies according to the particular metal sensor used.

A sensor cable 114 may be disposed along boom 106 to transmit information from the sensor to an operator of detection system 100. An electronics console 112 may be disposed on proximal boom section 106b, and may be in communication with sensor cable 114 in the extended position, shown in FIG. 1.

FIG. 2 illustrates detection system 100 in a stowed position. As discussed above, and as illustrated in FIG. 2, boom joint 110 may be embodied as a hinge. Winch 118 may move boom 106 between the extended and the stowed configurations by retracting cable 126. A forked receiver 138 may receive proximal boom section 106b, in order to prevent sway of boom 106 while vehicle 124 is in motion. A connector 202 may be disposed on sensor cable 114, which may be connected to electronics console 112 in the extended configuration, and disconnected from electronics console 112 in the stowed configuration. In other embodiments, boom 106 may have more than two sections (i.e. distal boom section 106a and proximal boom section 106b). For example, three or more boom sections may be used.

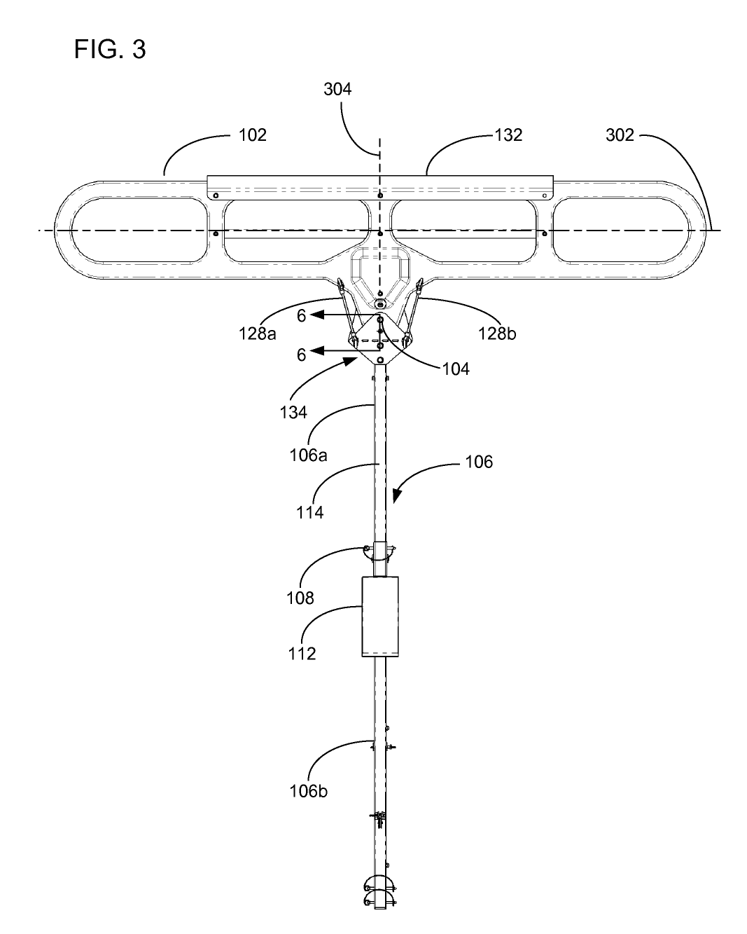

FIG. 3 illustrates a top view of sensor head 102. In the illustrated embodiment, sensor head 102 includes a major head axis 302, and a minor head axis 304. Major head axis 302 and minor head axis 304 are not features of sensor head 102, but are shown as phantom lines on FIG. 3 for purposes of discussion. Sensor cable 114 is not shown in FIG. 3 in order to avoid obscuring features illustrated in FIG. 3. In the orientation illustrated in FIG. 3, major head axis 302 is approximately perpendicular to boom 106. In the illustrated orientation, tensioning cable 128a and tensioning cable 128b are symmetrically disposed about the minor head axis 304 and about boom 106. Tensioning cables 128 are each connected to head attachment assembly 134 and sensor head 102. In other embodiments, sensor head attachment assembly 134 may be omitted, and tensioning cables 128 may be connected to boom 106. In the orientation illustrated in FIG. 3, the tension on tensioning cables 128a and 128b may be equal, so that tensioning cables 128 produce no net force that would cause sensor head 102 to pivot about pivot bolt 104.

FIG. 4 illustrates a perspective view of sensor head 102 in a pivoted orientation. As illustrated in FIG. 4, in the pivoted orientation, tensioning cables 128 are not of equal length. The length of tensioning cable 128b is reduced, while the length of tensioning cable 128a is increased. Tensioning cables 128 may comprise an elastic material, which when stretched exerts a restoring force proportional to how far the elastic material is stretched, and in the opposite direction. Accordingly, in the orientation illustrated in FIG. 4, tensioning cable 128a exerts a restoring force tending to result in the contraction of cable 128a and the extension of tensioning cable 128b. In this way, tensioning cables 128 are in equilibrium when sensor head 102 is in the orientation illustrated in FIG. 3, and exert a force tending to restore sensor head 102 to the orientation illustrated in FIG. 3 when sensor head 102 is in some other orientation. In one embodiment, tensioning cables 128 are embodied as polyurethane bungee cords having a diameter of 5/16″, commercially available as part no. 3961T3, from McMaster-Carr Supply Co., Santa Fe Springs, Calif.

FIG. 5 illustrates a side view of sensor head 102. Upper head attachment assembly 134a and lower head attachment assembly 134b are connected to distal boom section 106a. FIG. 5 illustrates pivot bolt 104, which defines a point about which sensor head 102 pivots. FIG. 5 further illustrates eyelet bolts 502 and 504, which may be secured respectively to sensor head 102 and head attachment assembly 134. Tensioning cable 128a is connected between eyelet bolts 502 and 504.

A leading edge protector 132 may be disposed along the leading edge of sensor head 102 to allow sensor head 102 to ride over fixed objects. As illustrated in FIG. 1 and FIG. 5, leading edge protector 132 connects to the top of sensor head 102, wraps around the leading edge of sensor head 102, and connects to the bottom of sensor head 102. Upon impact with a fixed object, leading edge protector 132 may cause sensor head 102 to ride up and over the fixed object (i.e. to increase the elevation of sensor head 102 with respect to the ground). Leading edge protector 132 has a slope from a distal end to a proximal end, which causes the height of sensor head 102 from the ground to increase when leading edge protector 132 contacts a fixed object. Leading edge protector 132 may be comprised of a variety of suitable materials, including ultra-high molecular weight polyethylene, high-density polyethylene, and the like.

FIG. 6 illustrates a cross-sectional view of a portion of sensor head 102 taken along line 6-6 in FIG. 3. FIG. 6 illustrates one embodiment of a lock mechanism 600 disposed between sensor head 102 and lower head attachment assembly 134b. Lock mechanism 600 is configured to lock sensor head 102 in a particular orientation with respect to the boom, and to release upon the application of a threshold force to sensor head 102. In response to the application of the threshold force, lock mechanism 600 releases and allows sensor head 102 to rotate. A cylindrical vertical spacer 618 may be disposed around pivot bolt 104. Vertical spacer 618 may help to maintain the alignment of sensor head 102 with respect to head attachment assembly 134. Cylindrical bushings 620 may be disposed around spacer 618. A nut 616 connects to bolt 104, to secure bolt 104 and sensor head 102 in place. A bearing 614 may be disposed between lower head attachment assembly 134b and sensor head 102. Bearing 614 may be configured to reduce friction between sensor head 102 and lower head attachment assembly 134b. In one embodiment, bearing 614 is made of ultra-high molecular weight polyethylene. In alternative embodiments, bearing 614 is made of the polymer commercially available under the name Teflon®, from E. I. Du Pont De Nemours and Company, Wilmington, Del.

Lock mechanism 600 includes a ball detent 602, which has a ball 608 at least partially captured within a cylinder 604. A spring 606 disposed within cylinder 604 biases ball 608. In a locked configuration of lock mechanism 600, ball 608 is received in an opening 612. The application of a force greater than the threshold force causes spring 606 to compress, and ball 608 enters into cylinder 604. The threshold force required to force ball 608 to enter cylinder 604 is determined by the properties of spring 606. Opening 612 may be chamfered to facilitate reengaging ball 608 in the locked configuration.

Those having skill in the art will recognize that many changes may be made to the details of the above-described embodiments without departing from the underlying principles of the present disclosure. The scope of the present invention should, therefore, be determined only by the following claims.

1. A system mountable to a vehicle for detecting a metallic object in the ground, the system comprising:
a boom having a proximal end configured to mount to the vehicle and a distal end;
a sensor head pivotally connected to the distal end of the boom, the sensor head comprising:
a metal sensor configured to detect the metallic object in the ground;
a lock mechanism configured to lock the sensor head in a first orientation with respect to the boom, and to release the sensor head from the first orientation upon the application of a threshold force to the sensor head, wherein the sensor head rotates in response to the application of the threshold force to a second orientation with respect to the boom;
a tensioning device configured to be in equilibrium when the sensor head is in the first orientation, and configured to exert a force to restore the sensor head to the first orientation when the sensor head is in the second orientation.

2. The system of claim 1, wherein the lock mechanism comprises a ball detent, the ball detent comprising:
a cylinder;
a biasing spring disposed within the cylinder;
a ball supported on the biasing spring and at least partially disposed within the cylinder;
a receptacle configured to engage with the ball;
wherein the ball is biased by the spring to engage the receptacle when the sensor head is in the first orientation; and
wherein the spring is compressed and the ball is further received within the cylinder when the sensor head is in the second orientation.

3. The system of claim 1, wherein the sensor head is configured to pivot in a plane substantially parallel to the plane of the boom.

4. The system of claim 1, wherein the sensor head has a primary axis, and wherein the primary axis of the sensor head is substantially perpendicular to the boom in the first orientation.

5. The system of claim 1, further comprising a leading edge protector connected to the sensor head, the leading edge protector comprising a surface having a slope from a distal end to a proximal end, and wherein the sloped surface is configured to cause the height of the sensor head from the ground to increase when the leading edge protector contacts a fixed object.

6. The system of claim 1, further comprising a hinge point at the proximal end of the boom, and wherein a height of the sensor head from the ground is adjustable by rotating the boom about the hinge point.

7. The system of claim 6, further comprising a winch, the winch coupled to the boom, and configured to rotate the boom about the hinge point.

8. The system of claim 7, further comprising:
a distance sensor configured to determine a distance of the sensor head from the ground; and
a control system configured to receive the distance from the distance sensor, and configured to control the winch in order to maintain the sensor head at a desired distance from the ground.

9. The system of claim 1, wherein the tensioning device further comprises:
an attachment assembly connected to the boom;
a first elastic restraint connected to the attachment assembly and connected to the sensor head;
a second elastic restraint connected to the attachment assembly and connected to the sensor head; and
wherein the first elastic restraint and the second elastic restraint are disposed approximately symmetrical about the boom.

10. The system of claim 1, wherein the system is moveable between an extended configuration and a stowed configuration.

11. The system of claim 10, wherein the boom and the sensor head are held substantially in parallel to the ground in the extended configuration.

12. The system of claim 10, wherein a first distance equal to the distance between the sensor head and the vehicle in the extended position is greater than a second distance equal to the distance between the sensor head and the vehicle in the stowed configuration.

13. The system of claim 10, wherein the boom comprises:
a distal boom section connected to the sensor head;
a proximal boom section configured to mount to the vehicle;
a hinge disposed between the distal boom section and the proximal boom section; and
wherein the hinge bends and the distal boom section and the proximal boom section are held in a plane that is approximately perpendicular to the ground in the stowed configuration.

14. The system of claim 10, wherein the system is moveable from the stowed configuration to the extended configuration without manual assembly.

15. The system of claim 1, wherein the sensor head comprises glass reinforced plastic.

16. A system mountable to a vehicle for detecting a metallic object in the ground, the system comprising:
a boom having a proximal end configured to mount to the vehicle and a distal end; and
a sensor head pivotally connected to the distal end of the boom, the sensor head comprising:
a metal sensor configured to detect the metallic object in the ground;
means for locking the sensor head in a first orientation with respect to the boom, and releasing the sensor head from the first orientation upon the application of a threshold force to the sensor head, wherein the sensor head rotates in response to the application of the threshold force to a second orientation with respect to the boom; and
means for exerting a force tending to restore the sensor head to the first orientation when the sensor head is in the second orientation.

17. A system comprising:
a sensor head pivotally connected to the distal end of the boom, the sensor head comprising:
a metal sensor configured to detect the metallic object in the ground;
a lock mechanism configured to lock the sensor head in a first orientation with respect to the boom, and to release the sensor head from the first orientation upon the application of a threshold force to the sensor head, wherein the sensor head rotates in response to the application of the threshold force to a second orientation with respect to the boom;
a tensioning device configured to be in equilibrium when the sensor head is in the first orientation, and configured to exert a force to restore the sensor head to the first orientation when the sensor head is in the second orientation.

18. The system of claim 17, wherein the lock mechanism comprises a ball detent, the ball detent comprising:
a cylinder;
a biasing spring disposed within the cylinder;
a ball supported on the biasing spring and at least partially disposed within the cylinder;
a receptacle configured to engage with the ball;
wherein the ball is biased by the spring to engage the receptacle when the sensor head is in the first orientation; and
wherein the spring is compressed and the ball is further received within the cylinder when the sensor head is in the second orientation.

19. The system of claim 17, wherein the sensor head is configured to pivot in a plane substantially parallel to the plane of the boom.

20. The system of claim 17, wherein the sensor head has a primary axis, and wherein the primary axis of the sensor head is substantially perpendicular to the boom in the first orientation.

21. The system of claim 17, further comprising a leading edge protector connected to the sensor head, the leading edge protector comprising a surface having a slope from a distal end to a proximal end, and wherein the sloped surface is configured to cause the height of the sensor head from the ground to increase when the leading edge protector contacts a fixed object.

22. The system of claim 17, wherein the tensioning device further comprises:
an attachment assembly connected to the boom;
a first elastic restraint connected to the attachment assembly and connected to the sensor head;
a second elastic restraint connected to the attachment assembly and connected to the sensor head; and
wherein the first elastic restraint and the second elastic restraint are disposed approximately symmetrical about the boom.

23. The system of claim 17, wherein the sensor head comprises glass reinforced plastic.
